(19) United States
(12) Patent Application Publication
(10) Pub. No.: US 2009/0267520 A1
(43) Pub. Date: Oct. 29, 2009

(54) LIGHTING CONTROL DEVICE

(75) Inventors: Kotaro Matsui, Shizuoka (JP); Takayoshi Kitagawa, Shizuoka (JP); Takao Sugiyama, Shizuoka (JP)

Correspondence Address: FISH & RICHARDSON P.C., P.O. BOX 1022, MINNEAPOLIS, MN, 55440-1022, US

(73) Assignee: Koito Manufacturing Co., Ltd., Tokyo (JP)

(21) Appl. No.: 12/427,017

(22) Filed: Apr. 21, 2009

(30) Foreign Application Priority Data
Apr. 28, 2008 (JP) 2008-117190

(51) Int. Cl. H05B 37/00

(52) U.S. Cl. 315/119

(57) ABSTRACT

A lighting control device includes a current driving portion for DC-controlling or PWM-controlling an LED unit, and a disconnection detection portion for detecting disconnection of the LED unit. The disconnection detection portion has a latch circuit and a reset portion. The latch circuit provides a disconnection detection signal after it is detected that disconnection has occurred for a prescribed time. The reset portion resets the disconnection detection signal based on prescribed conditions.

### CROSS-REFERENCE TO RELATED APPLICATION(S)

This application claims the benefit of priority of Japanese patent application no. 2008-117190, filed on Apr. 28, 2008, the disclosure of which is incorporated herein by reference.

### TECHNICAL FIELD

The present disclosure generally relates to a lighting control device for controlling lighting of a semiconductor light source that includes semiconductor light-emitting elements. More particularly, the present disclosure relates to a lighting control device having a small size and a disconnection detection function.

### BACKGROUND

Conventionally, lamps using semiconductor light-emitting elements such as LEDs (Light Emitting Diodes) as semiconductor light sources have been developed for use, for example, in vehicular lamps. Such vehicular lamps and the like generally use a lighting control device for controlling lighting of the LEDs.

When an abnormal event, such as a disconnection, occurs in a semiconductor light source, the lighting control device detects the disconnection by a series regulator connected in series with each semiconductor light source.

U.S. Pat. No. 7,327,051, for example, discloses a technique of protecting semiconductor light sources if an abnormal event occurs in a semiconductor light source when applying a prescribed current to semiconductor light sources connected in parallel with each other. In particular, the foregoing document discloses a lighting control circuit for monitoring an output voltage to the semiconductor light sources by a switching regulator, and controlling its operation within a safe range upon detection of an abnormal reduction in output voltage.

However, when the lighting control device of the related art has both a DC (direct current) lighting function using a DC voltage and a PWM (Pulse Wide Modulation) lighting function, the amount of time from occurrence of the disconnection to outputting of a disconnection signal and stopping of electric power output differs between the DC lighting operation and the PWM lighting operation. Accordingly, disconnection cannot be accurately detected.

### SUMMARY

Various aspects of the invention are set forth in the accompanying claims. For example, in one aspect, a lighting control device includes a current driving portion (e.g., circuitry) for DC-control or PWM-control of a semiconductor light-emitting element, and a disconnection detection portion (circuitry) for detecting disconnection of the semiconductor light-emitting element. The disconnection detection portion has a detection time setting portion (e.g., circuitry) and a reset portion (e.g., circuitry). The detection time setting portion provides a disconnection detection signal when it is detected that disconnection has occurred for a prescribed time (i.e., duration). The reset portion resets the disconnection detection signal based on prescribed conditions.

In some implementations, the time from generation of disconnection to outputting of a disconnection signal and stopping of electric power output can be made to be substantially the same between a DC lighting operation and a PWM lighting operation. Accordingly, occurrence of a disconnection can be accurately detected, and safety can be improved.

In some implementations, an off state of the PWM lighting operation and occurrence of disconnection can be distinguished from each other.

In some implementations, the time from occurrence of disconnection to outputting of a disconnection signal and stopping of electric power output can be made substantially the same for a DC lighting operation and a PWM lighting operation.

In some implementations, the prescribed time (i.e., duration) is defined by a simple structure.

In some implementations, the prescribed conditions are defined by a simple structure.

### BRIEF DESCRIPTION OF THE DRAWINGS

FIG. 1 is a structural diagram of a lighting system using a lighting control device according to an embodiment of the present invention.

FIG. 2 is a structural diagram showing more details of the lighting control device of FIG. 1.

FIG. 3 is a timing chart illustrating a DC lighting operation.

FIG. 4 is a timing chart illustrating a PWM lighting operation.

### DETAILED DESCRIPTION AND BEST MODE

A characteristic of a lighting control device according to some implementations is that the time from occurrence of disconnection (failure) to outputting of a disconnection signal and stopping of electric power output (failure latch) is substantially the same for a DC lighting operation and a PWM lighting operation.

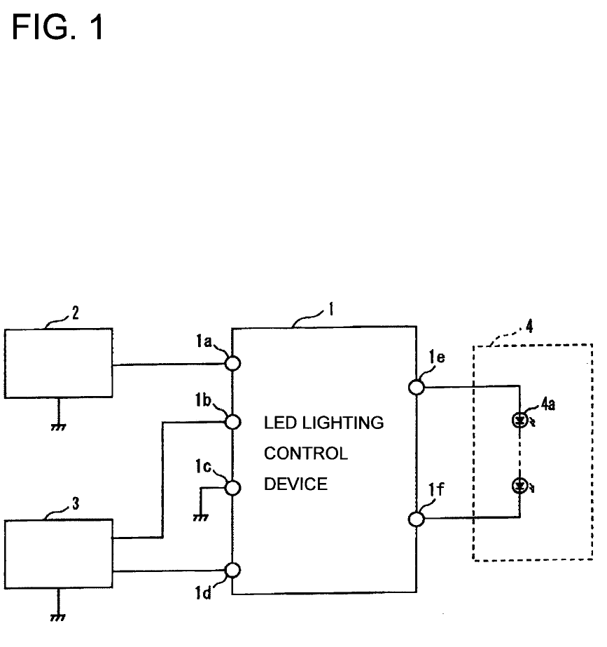

FIG. 1 shows and illustrates a structure of a lighting system using the lighting control device according to the embodiment of the present invention. This lighting system can be used for a vehicular lamp and the like.

As shown in FIG. 1, the lighting system includes a lighting control device 1, a power supply source 2 such as a DC/DC converter and a battery, a vehicle-side ECU (electronic control unit) 3, and an LED unit 4 having multiple LEDs 4a. The vehicular ECU integrally controls and manages various ECUs such as an engine control ECU.

The power supply source 2 is connected to a power supply terminal 1a of the lighting control device 1. The vehicle-side ECU 3 is connected to a PWM ON/OFF signal input terminal 1b and a disconnection detection terminal 1d of the lighting control device 1. The LED unit 4 is connected to terminals 1e, 1f of the lighting control device 1. The lighting control device 1 includes a ground terminal 1c in addition to the foregoing terminals.

In this structure, in a DC lighting operation, a PWM signal is held at a high level (Hi) by a PWM OFF signal supplied from the vehicle-side ECU 3, and the lighting control device 1 DC-lights the LEDs 4a of the LED unit 4. In a PWM lighting operation, on the other hand, a PWM signal is switched between a low level (Lo) and a high level (Hi) in a fixed cycle by a PWM ON signal supplied from the vehicle-side ECU 3, and the lighting control device 1 PWM-lights the LEDs 4a of the LED unit 4. If disconnection occurs in any LED 4a either during the DC lighting operation or the PWM lighting operation, the lighting control device 1 stops providing electric power after a predetermined time from detection of the disconnection. At the same time, the lighting control device 1 provides a disconnection detection signal from the disconnection detection terminal 1d to the vehicle-side ECU 3. This will be described in detail below.

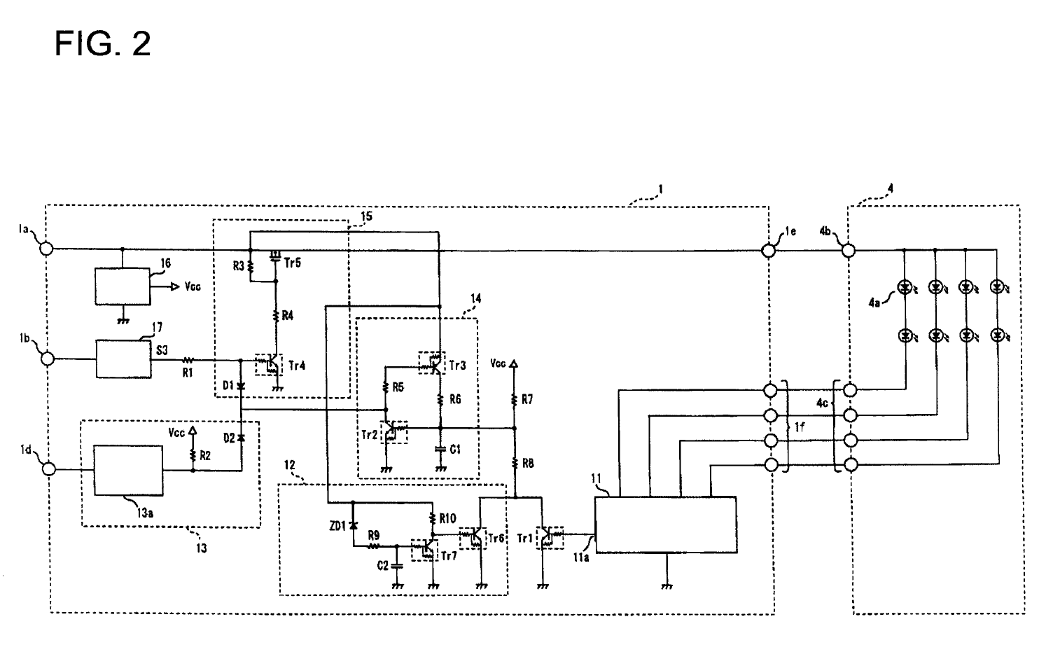

FIG. 2 shows and illustrates in more detail a structure of the lighting control device according to an example of the present invention. This lighting control device can be used, for example, in a vehicular lamp and the like.

As shown in FIG. 2, the lighting control device 1 includes a disconnection detection circuit 11, a reset circuit 12, a disconnection detection signal interface (disconnection detection outage interface) 13, a latch circuit 14, a current driving portion 15, a constant voltage Vcc generation circuit 16, and a PWM signal generation circuit 17. The LED unit 4 is arranged so that the groups of LED 4a are connected in parallel.

The PWM signal input terminal 1b is connected to the PWM signal generation circuit 17, and an output of the PWM signal generation circuit 17 is connected to a base of an NPN transistor Tr4 through a resistor R1. An emitter of the NPN-type transistor Tr4 is grounded, and a collector thereof is connected to a gate of a p-channel MOSFET (field effect transistor) Tr5 through a resistor R4. Moreover, a connection end of the resistor R4 and the gate of the p-channel MOSFET Tr5 is connected to a source side of the p-channel MOSFET Tr5 through a resistor R3.

The p-channel MOSFET Tr5 is connected to a power supply line extended from the power supply terminal 1a. A high breakdown voltage FET is used as the p-channel MOSFET Tr5 since a high voltage is applied thereto. Note that another constant voltage Vcc generation circuit 16 is also connected to the power supply line.

The terminal 1f is connected to the disconnection detection circuit 11, and a disconnection detection terminal 11a of the disconnection detection circuit 11 is connected to a base of an NPN transistor Tr1. An emitter of the NPN transistor Tr1 is grounded, and a collector thereof is connected to a constant voltage Vcc through resistors R7, R8. A connection end of the resistors R7, R8 is connected to a base of an NPN transistor Tr2. An emitter of the NPN transistor Tr2 is grounded, and a collector thereof is connected to a base of a PNP transistor Tr3 through a resistor R5. A collector of the PNP transistor Tr3 is grounded through a resistor R6 and a capacitor C1. A connection end of the resistor R6 and the capacitor C1 is connected to the base of the NPN transistor Tr2.

The latch circuit 14 serves as a detection time setting portion and is formed by the resistor R5, the resistor R6, the capacitor C1, the NPN transistor Tr2, and the PNP transistor Tr3.

A connection end of the collector of the NPN transistor Tr2 and the resistor R5 of the latch circuit 14 is connected to the disconnection detection signal interface 13 side. Specifically, the base of the NPN transistor Tr4 of the current driving portion 15 is connected to an anode of a diode D1, and a cathode of the diode D1 is connected to a cathode side of a diode D2 and is connected to a connection end of the diodes D1, D2. An anode of the diode D2 is connected to an outage interface circuit 13a. A connection end of the anode of the diode D2 and the outage interface circuit 13a is connected to the power supply through a resistor R2.

Thus, the disconnection detection signal interface 13 is formed by the diode D2, the resistor R2, the outage interface circuit 13a.

An emitter of the PNP transistor Tr3 of the latch circuit 14 is connected to the source side of the p-channel MOSFET Tr5 of the current driving portion 15. Thus, the lighting control device 1 is arranged to operate as follows: if the NPN transistor Tr2 of the latch circuit 14 is turned on and the PNP transistor Tr3 of the latch circuit 14 is turned on after a prescribed time from detection of disconnection, the p-channel MOSFET Tr5 is turned off, whereby supply of electric power is stopped. As described below, this prescribed time is determined by the time constant of the resistor R7 and the capacitor C1 and the on-state voltage of the NPN transistor Tr2.

The emitter of the PNP transistor Tr3 of the latch circuit 14 also is connected to a collector of an NPN transistor Tr7 through a resistor R10 of the reset portion 12. A connection end of the emitter of the PNP transistor Tr3 and the resistor R10 is connected to a cathode of a Zener diode ZD1, and an anode of the Zener diode ZD1 is connected to a base of the NPN transistor Tr7 through a resistor R9. A connection end of the resistor R9 and the base of the NPN transistor Tr7 is grounded through a capacitor C2. A connection end of the collector of the NPN transistor Tr7 and the resistor R10 is connected to a base of an NPN transistor Tr6. An emitter of the NPN transistor Tr6 is grounded, and a collector thereof is connected to a connection end of the resistor R8 and the collector of the NPN transistor Tr1.

Thus, the reset circuit 12 is formed by the resistors R9, R10, the capacitor C2, the Zener diode ZD1, and the NPN transistors Tr6, Tr7.

In this structure, during a DC lighting operation, the PWM signal generation circuit 17 receives a PWM OFF signal from the vehicle-side ECU 3 through the PWM signal input terminal 1b, and holds a PWM signal at a Hi level. As a result, the NPN transistor Tr4 is turned on and the p-channel MOSFET Tr5 is turned on, whereby a DC voltage which is supplied from the power supply source 2 through the power supply terminal 1a is supplied to the LED unit 4 side, and the LED unit 4 is DC-lit by a DC current.

During a PWM lighting operation, the PWM signal generation circuit 17 receives a PWM ON signal from the vehicle-side ECU 3 through the PWM signal input terminal 1b, and switches a PWM signal between a Hi level and a Lo level in a fixed cycle. As a result, the NPN transistor Tr4 and the p-channel MOSFET Tr5 are turned on and off in the fixed cycle, whereby supply of the DC voltage, which is supplied from the power supply source 2 through the power supply terminal 1a, to the LED unit 4 side is controlled, and the LED unit 4 is PWM-lit.

If a current stops flowing as the result of a disconnection of any LED 4a, the disconnection detection circuit 11 detects the disconnection and supplies a Lo-level signal to the base of the NPN transistor Tr1 from the disconnection detection terminal 11a. As a result, the NPN transistor Tr1 is turned off, the power supply voltage Vcc is applied to the latch circuit 14 side through the resistor R7, and charges are accumulated in the capacitor C1. When the charging is completed after a predetermined time determined by the time constant of the resistor R7 and the capacitor C1, the NPN transistor Tr2 is turned on. The NPN transistor Tr2 is held in the on state until the latch circuit 14 is reset.

When the NPN transistor Tr2 is thus turned on, the PNP transistor Tr3 is turned on and the p-channel MOSFET Tr5 is turned off, whereby supply of electric power to the LED unit 4 is stopped. The disconnection detection signal interface 13 provides a Lo-level disconnection detection signal simultaneously with the stopping of electric power supply to the LED unit 4.

Right after a DC voltage is applied from the power supply source 2, the NPN transistor Tr7 is turned off and the NPN transistor Tr6 is turned on for a prescribed time determined by the time constant of the resistor R9 and the capacitor C2 of the reset circuit 12, whereby charges accumulated in the capacitor C1 are discharged, and the latch circuit 14 is reset (power-on reset). Moreover, when the DC voltage reduces to a predetermined value or less, the NPN transistor Tr7 is turned off and the NPN transistor Tr6 is turned on, whereby the latch circuit 14 is reset (reset upon DC voltage reduction)

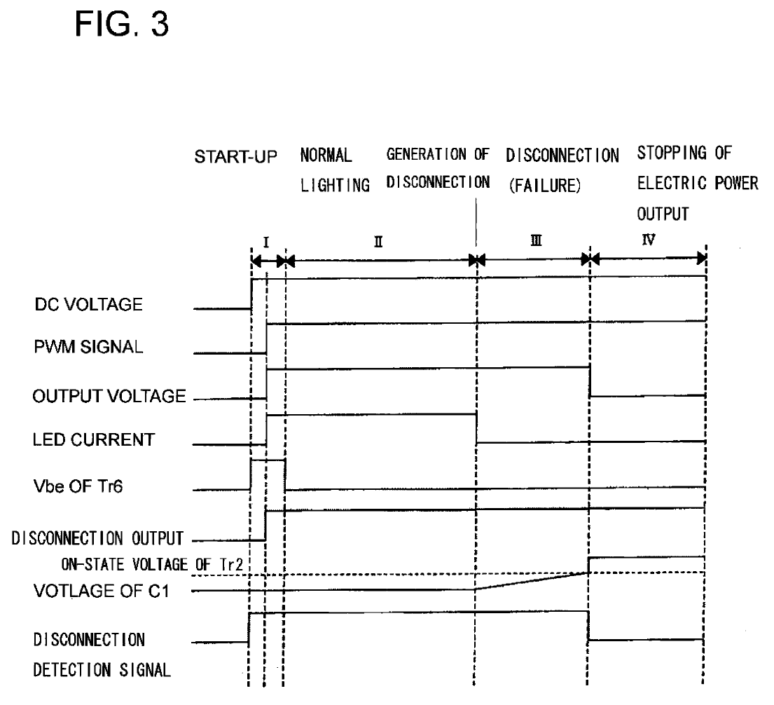

Processing in the DC lighting operation is described in detail with reference to the timing chart of FIG. 3.

Period I: Start-Up

A DC voltage is applied from the power supply source 2, and a PWM signal which is provided from the PWM signal generation circuit 17 rises to a Hi level slightly after the DC voltage application. As a result, the NPN transistor Tr4 of the current driving portion 15 is turned on, and the p-channel MOSFET Tr5 of the current driving portion 15 is turned on, whereby a DC current flows to the LED unit 4. In this case, the disconnection detection circuit 11 determines that the operating condition is normal, and a disconnection detection signal which is output from the disconnection detection terminal 11a rises to a Hi level. As no current flows to the LEDs 4a of the LED unit 4 during a period from the rise of the DC voltage to the rise of the PWM signal, the disconnection detection circuit 11 determines that disconnection has occurred. However, since the NPN transistor Tr6 of the reset portion 12 is on during this period, charges in the capacitor C1 are discharged and the latch circuit 14 is, therefore, reset.

Period II: Normal Lighting

The PWM signal which is provided from the PWM signal generation circuit 17 is fixed to a Hi level, whereby the NPN transistor Tr4 and the p-channel MOSFET Tr5 of the current driving portion 15 continuously remain in an on state. As a result, a DC current flows to the LED unit 4, and the LED unit 4 is DC-lit. In this case, as the current keeps flowing to the LED unit 4 normally, the disconnection detection circuit 11 determines that the operating condition is normal, and the disconnection detection signal which is provided from the disconnection detection terminal 11a remains at a Hi level. As the NPN transistor Tr1 is kept closed, the latch circuit 14 remains in the reset state. Accordingly, a disconnection detection signal which is provided from the outage interface circuit 13a of the disconnection detection signal interface 13 remains at a Hi level (normal).

Period III: Disconnection (Failure)

If any LED 4a of the LED unit 4 is disconnected and the DC current stops flowing to the LEDs 4a, the disconnection detection circuit 11 determines that disconnection has occurred, and the disconnection detection signal which is provided from the disconnection detection terminal 11a falls to a Lo level. As a result, the NPN transistor Tr1 is turned off, and the power supply voltage Vcc is applied to the latch circuit 14 through the resistor R7, whereby the capacitor C1 starts being charged. The capacitor C1 is charged for a predetermined time determined by the time constant of the resistor R7 and the capacitor C1 and the on-state voltage of the NPN transistor Tr2. In other words, the latch circuit is released from the reset state. During this period, the p-channel MOSFET Tr5 remains in the on-state and the disconnection detection signal remains at a Hi level.

Period IV: Stopping of Electric Power Output

When the voltage of the capacitor C1 rises to the on-state voltage of the NPN transistor Tr2 or higher as a result of the charging with the constant voltage Vcc, the NPN transistor Tr2 is turned on and the PNP transistor Tr3 is turned on, whereby latch is implemented. At the same time, the p-channel MOSFET Tr5 of the current driving portion 15 is turned off to stop electric power output, the disconnection detection signal which is provided from the outage interface circuit 13a of the disconnection detection signal interface 13 is rendered to a Lo level (abnormal), and disconnection information is provided to the outside (the vehicle-side ECU 3).

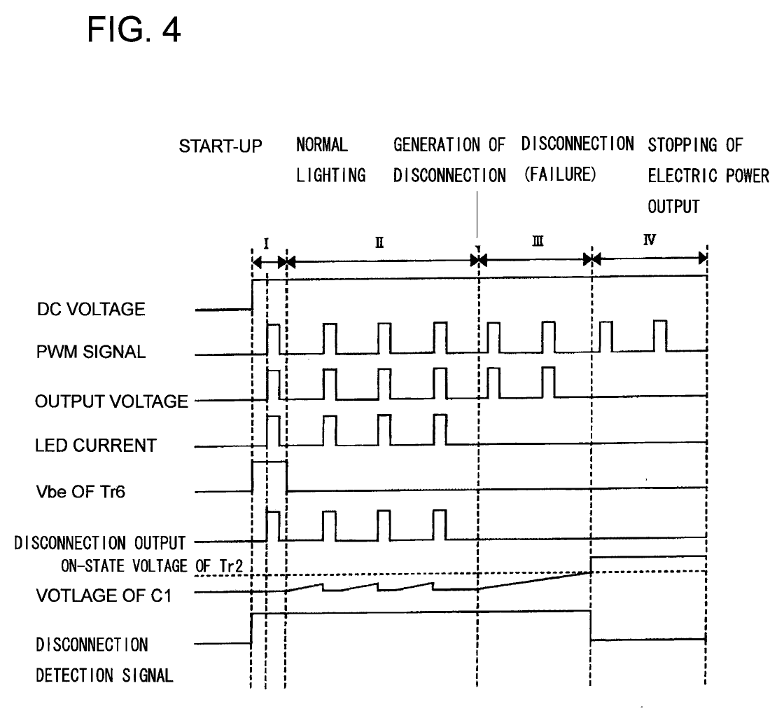

Next, processing in the PWM lighting operation is described in detail with reference to the timing chart of FIG. 4. In particular, a characteristic period II that differs from FIG. 3 is described.

Period II: Normal Lighting

In the PWM lighting operation, the PWM signal generation circuit 17 receives a PWM ON signal from the vehicle-side ECU 3 through the PWM signal input terminal 1b, and switches a PWM signal between Hi and Lo levels in a fixed cycle. As a result, the NPN transistor Tr4 and the p-channel MOSFET Tr5 are turned on and off in the fixed cycle. Supply of a DC voltage, which is supplied from the power supply source 2 through the power supply terminal 1a, to the LED unit 4 side is thus controlled, whereby the LED unit 4 is PWM-lit.

During a period in which a current is flowing to the LEDs 4a, the disconnection detection circuit 11 determines that the operating condition is normal, and holds a disconnection detection signal at a Hi level. During a period in which no current is flowing to the LEDs 4a, the disconnection detection circuit 11 determines that disconnection has occurred, and holds the disconnection detection signal at a Lo level. In this case, during a period in which the PWM signal is at a Lo level, that is, during a period in which no current is flowing to the LEDs 4a, the latch circuit 14 is released from the reset state, and the capacitor C1 starts being charged with the power supply voltage Vcc through the resistor R7.

When the PWM signal rises to a Hi level thereafter, the disconnection detection signal rises to a Hi level. As a result, the NPN transistor Tr1 is turned on and the capacitor C1 is rapidly discharged, whereby the latch circuit 14 is reset. In this case, the time constant of the resistor R7 and the capacitor C1 is set to a sufficiently large value with respect to the cycle of the PWM signal. By setting the time constant in this manner, the voltage of the capacitor C1 does not exceed the on-state voltage of the NPN transistor Tr2 during a period in which the PWM signal is at a Lo level in the normal lighting. Therefore, the latch circuit 14 does not operate, and the disconnection detection signal remains at a Hi level.

As has been described above, in the lighting control device according to the foregoing example, the time it takes to provide a disconnection signal and to perform failure latch is made substantially the same for a DC lighting operation and a PWM light control operation of the LED unit, and disconnection can be accurately detected.

Although specific details of an embodiment of the present invention have been described above, the present invention is not limited to these details, and various modifications can be made without departing from the scope of the present invention. Accordingly, other implementations are within the scope of the claims.

What is claimed is:

1. A lighting control device comprising:
a current driving circuit portion for DC-controlling or PWM-controlling a semiconductor light-emitting element; and a disconnection detection circuit portion for detecting disconnection of the semiconductor light-emitting element, wherein, the disconnection detection circuit portion has a detection time setting portion and a reset portion,
wherein the detection time setting portion is arranged to provide a disconnection detection signal when it is detected that disconnection has occurred for a prescribed time, and
wherein the reset portion is arranged to reset the disconnection detection signal based on prescribed conditions.

2. The lighting control device according to claim 1 wherein the prescribed time is longer than a cycle of the PWM control.

3. The lighting control device according to claim 1 wherein the prescribed time is substantially the same both in a DC lighting operation and a PWM lighting operation.

4. The lighting control device according to claim 1 wherein the detection time setting portion is arranged to set a detection time by turning on a switching element when a prescribed time determined by a time constant of a resistor and a capacitor has passed.

5. The lighting control device according to claim 1 wherein the reset portion is arranged to reset the disconnection detection signal based on prescribed conditions determined by a time constant of a resistor and a capacitor.
